(19) United States
(12) Patent Application Publication
(10) Pub. No.: US 2025/0186942 A1
(43) Pub. Date: Jun. 12, 2025

(54) ROTARY REACTOR

(71) Applicant: TOHOKU UNIVERSITY, Sendai-shi, Miyagi (JP)

(72) Inventor: Nobuhiro MARUOKA, Sendai-shi (JP)

(21) Appl. No.: 18/846,530

(22) PCT Filed: Mar. 14, 2023
(86) PCT No.: PCT/JP2023/009833

§ 371 Date: Sep. 12, 2024

(30) Foreign Application Priority Data
Mar. 14, 2022 (JP) 2022-039592

(51) Int. Cl. B01D 53/62; B01D 1/00; B01D 1/14; B01D 53/78; F28F 5/02

(52) U.S. Cl. CPC B01D 53/62; B01D 1/0064; B01D 1/14; B01D 53/78; F28F 5/02; B01D 2251/306; B01D 2251/606; B01D 2257/504

(57) ABSTRACT

A heat transfer cylindrical body formed in a cylindrical shape with a central axis as a rotation center, and through which a first medium flows through an inside of the heat transfer cylindrical body, an outer cylinder that is disposed more outward than the heat transfer cylindrical body in a radial direction and through which a second medium different from the first medium flows between the outer cylinder and the heat transfer cylindrical body, a blade provided more outward than the heat transfer cylindrical body in the radial direction and extending along the radial direction toward the heat transfer cylindrical body, and a supply device that allows a fluid to flow into a reaction space between the heat transfer cylindrical body and the outer cylinder are provided, and the heat transfer cylindrical body is supported so as to be rotatable about the central axis with respect to the outer cylinder.

### CROSS-REFERENCE TO RELATED APPLICATIONS

This application is the U.S. National Stage entry of International Application No. PCT/JP2023/009833, filed on Mar. 14, 2023, which, in turn, claims priority to Japanese Patent Application No. 2022-039592, filed on Mar. 14, 2022, both of which are hereby incorporated herein by reference in their entireties for all purposes.

### TECHNICAL FIELD

The present invention relates to a rotary reactor.

### BACKGROUND ART

In the known art, a reactor vessel for performing a reaction between fluids, evaporation of a liquid, and the like by stirring and mixing different types of fluids (for example, liquid and gas) is known. In such a reactor vessel, various techniques for efficiently generating a reaction between fluids have been proposed.

For example, Patent Document 1 (Japanese Patent Application Laid-Open No. 9-276675) discloses a configuration of a gas-liquid contact device that causes a gas-liquid reaction, the gas-liquid contact device including a stirring tank containing a liquid, a rotating body that is disposed in the liquid and rotates around a rotation axis, and a gas supply source that blows gas into the liquid from below the rotating body. In the rotating body, a pair of upper and lower disks are overlapped as one set, and an inlet is formed at the center of the lower disk. A large number of cylindrical small chambers opened to the other disk side are arranged and formed on the surfaces of the respective disks facing each other, and the small chamber of the upper disk and the small chamber of the lower disk are arranged at different positions so as to communicate with the other small chambers facing each other.

According to the technique described in Patent Document 1, a mixed fluid of gas and liquid blown from below the rotating body flows into each small chamber from the inlet of the disk. While the flowing mixed fluid is discharged to the outside of the rotating body by a centrifugal force of the rotating body, the gas is dispersed by generation of a vortex flow or generation of cavitation due to the inflow into each small chamber. As a result, micronized bubbles are discharged into the stirring tank, so that a gas-liquid contact area can be increased.

### Citation List

### Patent Document

Patent Document 1: Japanese Patent Application Laid-Open No. 9-276675

### SUMMARY OF INVENTION

### Technical Problem

In these reactors, it is desired to further increase reaction speed. In the technique described in Patent Document 1, the size and density of bubbles may be different between the vicinity of the rotating body and other places. Thus, in the technique described in Patent Document 1, there is a possibility that the gas-liquid contact area (reaction interfacial area) cannot be maximized. Therefore, the known technique has a problem in that the reaction speed is increased while heat transfer rate is further increased by increasing the reaction interfacial area.

Thus, an object of the present invention is to provide a rotary reactor capable of increasing heat transfer rate and increasing reaction speed as compared with the known art.

### Solution to Problem

To solve the problems described above, the present invention adopts the following means.

(1) A rotary reactor according to one aspect of the present invention includes: a heat transfer cylindrical body formed in a cylindrical shape with a central axis as a rotation center and through which a first medium flows through an inside of the heat transfer cylindrical body: an outer cylinder that is disposed more outward than the heat transfer cylindrical body in a radial direction and through which a second medium different from the first medium flows between the outer cylinder and the heat transfer cylindrical body: a blade provided more outward than the heat transfer cylindrical body in the radial direction and extending along the radial direction toward the heat transfer cylindrical body: and a supply device that allows a fluid to flow into a reaction space between the heat transfer cylindrical body and the outer cylinder, wherein the heat transfer cylindrical body is supported so as to be rotatable about the central axis with respect to the outer cylinder, and a fluid having a plurality of phases different from each other is supplied to the reaction space.

(2) In the rotary reactor according to (1), the fluid having the plurality of phases may include at least gas and liquid, and the gas flowing into the reaction space may be dispersed by relative rotation of the heat transfer cylindrical body with respect to the blade to increase a reaction interfacial area.

(3) In the rotary reactor according to (2), the liquid may be an alkaline solution, and the gas may be carbon dioxide.

(4) In the rotary reactor according to (2), the liquid may be seawater, and the gas may be air.

(5) In the rotary reactor according to any one of (1) to (4), the supply device may include a pump, and a supply pipe that is connected to the pump and supplies the fluid to the reaction space.

### Advantageous Effects of Invention

According to the present invention, it is possible to provide a rotary reactor capable of increasing heat transfer rate and increasing the reaction speed as compared with the known art.

### BRIEF DESCRIPTION OF DRAWINGS

FIG. 1 is a cross-sectional view of a rotary reactor according to a first embodiment.

FIG. 2 is a cross-sectional view taken along line II-II of FIG. 1.

FIG. 3 is a graph showing a temporal change in a hydrogen ion index (pH) in a reaction space.

FIG. 4 is a graph showing a temporal change in absorption rate in a reaction space.

FIG. 5 is a graph showing a relationship between the hydrogen ion index (pH) and the absorption rate.

FIG. 6 is a graph showing a relationship between a carbon dioxide concentration and the absorption rate.

FIG. 7 is a graph showing a relationship between the number of rotations of a heat transfer cylindrical body and a volumetric mass transfer coefficient in the vicinity of pH 8.

FIG. 8 is a graph showing the relationship between the number of rotations of the heat transfer cylindrical body and the volumetric mass transfer coefficient in the vicinity of pH 10.

FIG. 9 is a cross-sectional view of a rotary reactor according to a second embodiment.

### DESCRIPTION OF EMBODIMENT

Hereinafter, preferred embodiments of the present invention will be described in detail with reference to the drawings, but the present invention is not limited to the drawings. In the following description and drawings, the same or corresponding elements are denoted by the same reference numerals, and redundant description may be omitted.

### First Embodiment

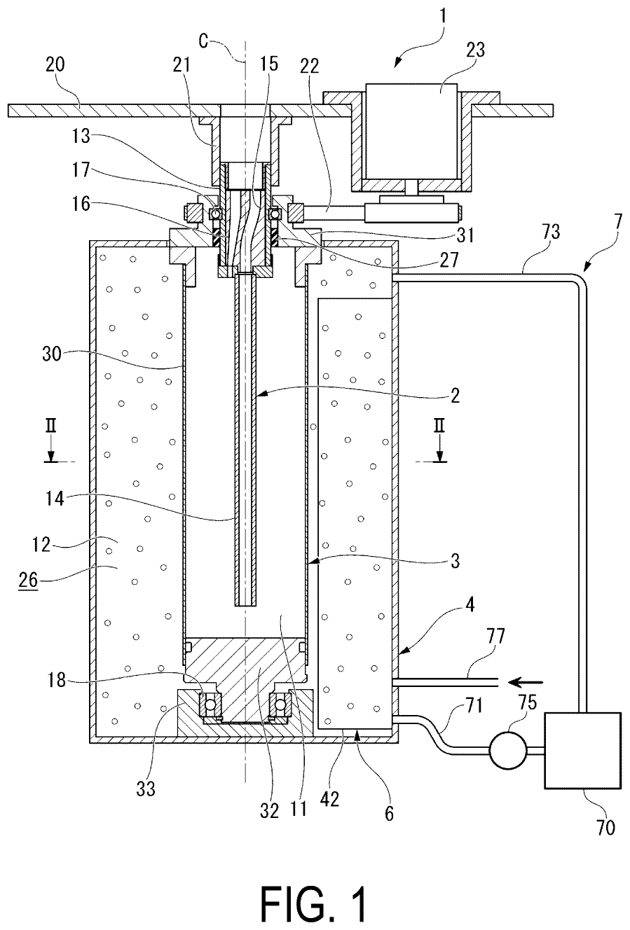

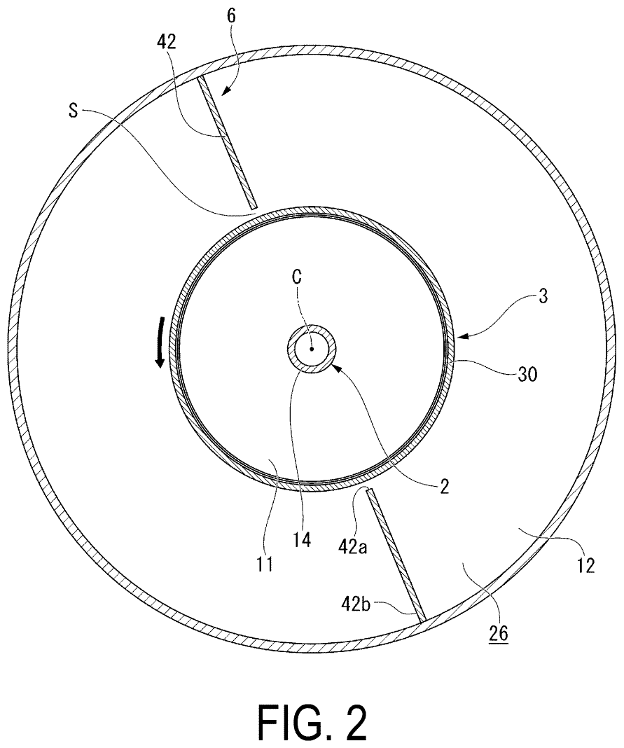

FIG. 1 is a cross-sectional view of a rotary reactor 1 according to a first embodiment when viewed from a horizontal direction. FIG. 2 is a cross-sectional view taken along line II-II of FIG. 1.

A rotary reactor 1 shown in FIG. 1 is a device for, when predetermined reactions are generated in various substances (“a fluid having a plurality of phases different from each other” in the claims) present in a reaction space 26, efficiently generating these reactions. As the “various substances present in the reaction space”, liquid and gas will be described as examples in the present embodiment: however, solid may be included. The substance may also be an immiscible multiphase liquid such as water and oil. In the following description, “various substances present in the reaction space” may be simply referred to as “fluid”. The “reaction” in the present embodiment includes a chemical reaction between different substances, evaporation, condensation, absorption, precipitation, and the like of liquid.

The rotary reactor 1 includes a central member 2, a heat transfer cylindrical body 3, an outer cylinder 4, a plurality of blades 6, and a supply device 7.

The central member 2 is formed in a cylindrical shape centered on a central axis C. The central member 2 extends with a direction along the central axis C as a longitudinal direction. The central axis C extends, for example, along a vertical direction. The central member 2 is formed of a material having high strength such as stainless steel. In the following description, the direction along the central axis C of the central member 2 may be referred to as an axial direction, a direction orthogonal to the axial direction may be referred to as a radial direction, and a direction around the axial direction may be referred to as a circumferential direction.

The central member 2 includes an attachment base portion 13, a central member body 14, an introduction pipe 15, and a discharge pipe 16. The attachment base portion 13 is provided at one end portion (upper end portion) in the axial direction. The attachment base portion 13 is formed in a cylindrical shape centered on the central axis C. The attachment base portion 13 is fixed to a housing 20 provided on one side in the axial direction with respect to the central member 2. Specifically, the housing 20 has a cylindrical protrusion 21 provided coaxially with the central axis C, and one end portion of the attachment base portion 13 is inserted into an inner peripheral portion of the cylindrical protrusion 21. The attachment base portion 13 is fixed to the housing 20 by a fastening member such as a bolt in a state of being inserted into the cylindrical protrusion 21. The attachment base portion 13 may be fixed to the housing 20 by a method other than fastening, such as welding. The attachment base portion 13 and the housing 20 may be integrally formed.

The central member body 14 is connected to the other end portion (lower end portion) of the attachment base portion 13. The central member body 14 extends downward in the axial direction from the attachment base portion 13. The central member body 14 is formed in a cylindrical shape having a diameter smaller than that of the attachment base portion 13. A lower end portion of the central member body 14 is open. The inside of the attachment base portion 13 and the central member body 14 thus formed is a cavity through which a first medium 11 can flow. The first medium 11 flows through the inside of the central member 2 from the upper side to the lower side in the axial direction, and is discharged from the lower end portion to the outside of the central member 2. For example, the central member 2 and the attachment base portion 13 may be separately formed and then fixed to each other by a fastening member, or may be integrally formed. The outer diameters of the attachment base portion 13 and the central member body 14 may be made equal to each other. For example, one of the attachment base portion 13 and the central member body 14 may be extended in the axial direction to serve as the other of the attachment base portion 13 and the central member body 14.

The introduction pipe 15 and the discharge pipe 16 are provided at an end portion (one end portion) on the housing 20 side in the axial direction of the central member 2. The introduction pipe 15 and the discharge pipe 16 are provided inside the attachment base portion 13. The introduction pipe 15 is connected to one end portion of the central member body 14. The introduction pipe 15 supplies the first medium 11 to the inside of the central member body 14. The discharge pipe 16 discharges the first medium 11 that has moved from the other side to the one side in the axial direction on the radially outer side of the central member body 14.

As shown in FIGS. 1 and 2, the heat transfer cylindrical body 3 is disposed more outward than the central member 2 in the radial direction. The heat transfer cylindrical body 3 is formed in a cylindrical shape coaxial with the central axis C. A length along the axial direction of the heat transfer cylindrical body 3 is longer than a length along the axial direction of the central member 2. The first medium 11 flowing in through the central member 2 flows more inward than the heat transfer cylindrical body 3 in the radial direction, that is, radially between the heat transfer cylindrical body 3 and the central member 2.

The heat transfer cylindrical body 3 includes a main body portion 30, a first closing member 31, and a second closing member 32. The main body portion 30 is formed in a cylindrical shape coaxial with the central axis C. The main body portion 30 is formed of a material having good thermal conductivity. Examples of the material of the heat transfer cylindrical body 3 include aluminum and copper. As the material of the heat transfer cylindrical body 3, for example, stainless steel, titanium, and the like may be used in addition to the above-described materials. In this case, it is particularly suitable under an environment where corrosion resistance is required. In addition, when the medium is a molten salt and the like, ceramics or the like may be used as the material of the heat transfer cylindrical body 3.

The first closing member 31 closes an opening on the housing 20 side in the axial direction of the main body portion 30. The first closing member 31 is connected to the main body portion 30. A seal portion 27 is provided at a predetermined position between the first closing member 31 and the central member 2. The seal portion 27 prevents the first medium 11 in the heat transfer cylindrical body 3 from leaking to the outside.

The second closing member 32 closes an opening on a side opposite to the housing 20 in the axial direction of the main body portion 30. The second closing member 32 is attached to an inner peripheral surface of the main body portion 30. The second closing member 32 is provided at a distance downward from the lower end portion of the central member body 14. By providing the first closing member 31 and the second closing member 32, the first medium 11 in the heat transfer cylindrical body 3 can communicate with the inside and the outside only through the introduction pipe 15 and the discharge pipe 16 of the central member 2.

A relay member 33 is connected to the second closing member 32 via a second bearing 18. The second bearing 18 is, for example, a rolling bearing. The second closing member 32 is fixed to an inner peripheral surface of the second bearing 18. The second bearing 18 is attached to a lower end portion of the second closing member 32. The relay member 33 is fixed to an outer peripheral surface of the second bearing 18. A lower end portion of the relay member 33 is connected to the outer cylinder 4. Thus, the main body portion 30 and the second closing member 32 of the heat transfer cylindrical body 3 and the outer cylinder 4 are relatively rotatable with respect to each other.

The second bearing 18 and the outer cylinder 4 may be directly connected without providing the relay member 33. That is, the second closing member 32 may be fixed to the inner peripheral surface of the second bearing 18, and the outer cylinder 4 described later in detail may be fixed to the outer peripheral surface of the second bearing 18.

The heat transfer cylindrical body 3 thus formed is configured to be rotatable about the central axis C as a rotation center. Specifically, as shown in FIG. 1, the heat transfer cylindrical body 3 is rotatably supported with respect to the central member 2 via bearings 17 and 18 arranged at the respective axial ends of the central member 2. Among the bearings arranged at both ends, the first bearing 17 located on the housing 20 side is, for example, a rolling bearing including an inner ring, an outer ring, and a rolling element. The inner ring of the first bearing 17 is inserted into and fixed to the attachment base portion 13. The outer ring of the first bearing 17 is fixed to an inner peripheral surface of the first closing member 31 of the heat transfer cylindrical body 3. The first bearing 17 may be an annular slide bearing.

Among the bearings arranged at both ends, the second bearing 18 located on the opposite side of the housing 20 is, for example, a rolling bearing disposed coaxially with the central axis C. The outer peripheral surface of the second bearing 18 is fixed to the relay member 33. The second closing member 32 is fixed to the inner peripheral surface of the second bearing 18.

A drive belt 22 is wound around an outer peripheral portion of the heat transfer cylindrical body 3. The drive belt 22 is connected to a motor 23 provided in the housing 20. When the motor 23 is driven, the heat transfer cylindrical body 3 is driven by the drive belt 22 and rotates about the central axis C. A driving power of the drive belt 22 is not limited to the motor, and may be power such as water power or wind power.

The outer cylinder 4 is formed in a cylindrical shape coaxial with the heat transfer cylindrical body 3. The outer cylinder 4 is disposed more outward than the heat transfer cylindrical body 3 in the radial direction at a predetermined interval. A second medium 12 different from the first medium 11 can flow through a space inside the outer cylinder 4 and outside the heat transfer cylindrical body 3 in the radial direction. In the present embodiment, the temperature of the first medium 11 is different from the temperature of the second medium 12. The second medium 12 is, for example, a liquid. A space between the outer cylinder 4 and the heat transfer cylindrical body 3 is the reaction space 26 in which various fluids including the second medium 12 are stirred and mixed to cause a predetermined reaction in the fluid. The outer cylinder 4 is formed in a closed water tank shape so that the medium inside the outer cylinder 4 does not flow out. An upper end portion of the outer cylinder 4 is disposed with a gap from the first closing member 31 of the heat transfer cylindrical body 3, for example. Alternatively, the upper end portion of the outer cylinder 4 is connected to the first closing member 31 via a sealing material or the like. The outer cylinder 4 is non-rotatably formed. In other words, the heat transfer cylindrical body 3 is supported so as to be rotatable relative to the outer cylinder 4. For example, the upper end portion and the lower end portion of the outer cylinder 4 may be closed by a closing plate (not shown).

The plurality of blades 6 are disposed between the heat transfer cylindrical body 3 and the outer cylinder 4. In other words, the plurality of blades 6 are arranged in the reaction space 26. As shown in FIG. 1, the plurality of blades 6 are attached to the outer cylinder 4. The blade 6 has a blade body 42.

As shown in FIGS. 1 and 2, the blade body 42 extends from the outer cylinder 4 toward the heat transfer cylindrical body 3 along the radial direction. A plurality of the blade bodies 42 are provided at equal intervals in the circumferential direction. In the present embodiment, the blade body 42 is formed in a rectangular plate shape elongated in the axial direction, and is disposed so as to extend in the radial direction of the heat transfer cylindrical body 3 when viewed from above as shown in FIG. 2. The blade body 42 is formed of, for example, a metal material. As shown in FIG. 2, a gap S is provided between a distal end portion 42a located on the radially inner side of the blade body 42 and an outer peripheral surface of the heat transfer cylindrical body 3. In other words, the plurality of blades 6 are provided so as to be spaced apart from the heat transfer cylindrical body 3 on the outer side in the radial direction. For example, in a system from which a solid phase comes out, such as a salt making process described later, the plurality of blades 6 may be arranged in close contact with the heat transfer cylindrical body 3.

Each of the blade bodies 42 is attached to an inner peripheral surface of the outer cylinder 4 at a proximal end portion 42b located radially outside. Thus, when the heat transfer cylindrical body 3 rotates, the blade body 42 does not rotate.

The blade 6 thus formed rotates relative to the heat transfer cylindrical body 3 when the heat transfer cylindrical body 3 rotates (actually, the heat transfer cylindrical body 3 rotates). As a result, the heat transfer cylindrical body 3 guides the fluid, and the guided fluid hits the blade 6 and changes its direction, thereby promoting stirring. The blade serves to stir the fluid in the reaction space 26 and to shear and finely disperse the gas supplied into the reaction space 26. By making the bubbles finer in this manner, a surface area of the entire bubbles can be increased, the reaction with the second medium 12 can be promoted, and reaction speed is improved. In addition, the blade 6 plays a role of promoting the movement of a substance in the reaction space 26 by stirring the fluid, thereby improving the reaction speed in the reaction space 26.

As shown in FIG. 1, the supply device 7 is provided outside the outer cylinder 4. The supply device 7 supplies a fluid to the reaction space 26 between the heat transfer cylindrical body 3 and the outer cylinder 4. In the present embodiment, the supply device 7 supplies, for example, liquid and gas to the reaction space 26. The supply device 7 includes a tank 70, a supply pipe 71, a recovery pipe 73, a pump 75, and a second supply pipe 77.

The tank 70 is provided outside the outer cylinder 4. The tank 70 stores a liquid to be supplied to the reaction space 26.

The supply pipe 71 connects the tank 70 and the reaction space 26. The supply pipe 71 is connected to a lower portion of the outer cylinder 4. The supply pipe 71 supplies the liquid in the tank 70 to a lower portion of the reaction space 26.

The recovery pipe 73 connects the tank 70 and the reaction space 26. The recovery pipe 73 is connected to an upper portion of the outer cylinder 4. The recovery pipe 73 recovers at least one of the liquid and the gas in the reaction space 26 and returns it to the tank 70.

The pump 75 is provided in the middle of the supply pipe 71. When the pump 75 is driven, the liquid is supplied from the tank 70 to the reaction space 26 through the supply pipe 71, and the pressure in the reaction space 26 becomes high, so that the fluid (liquid and gas) in the reaction space 26 is returned to the tank 70 via the recovery pipe 73. By driving the pump 75 in this way, the supply device 7 circulates the fluid in the reaction space 26.

The second supply pipe 77 is provided separately from the supply pipe 71. The second supply pipe 77 is connected to the end portion of the outer cylinder 4. The second supply pipe 77 supplies a predetermined gas used for the reaction to the lower portion of the reaction space 26. An outlet of the second supply pipe 77 may be connected to the supply pipe 71. In this case, a mixed fluid of the gas and the liquid in the tank 70 is supplied to the lower portion of the reaction space 26.

### Carbon Dioxide Absorption Process Using Rotary Reactor)

Next, a carbon dioxide absorption process (hereinafter, referred to as the absorption process) using the rotary reactor 1 described above will be described.

When performing the absorption process, the second medium 12 is an alkaline solution. Specifically, the alkaline solution is an absorbent such as an aqueous potassium carbonate solution or amines. Hereinafter, in the present embodiment, a case where the second medium 12 is an aqueous potassium carbonate solution will be described as an example. The first medium 11 is, for example, water having a temperature lower than that of the second medium 12. The first medium 11 may be a fluid having a temperature lower than that of the second medium 12, and may be a fluid other than water. The aqueous potassium carbonate solution is supplied from the tank 70 of the supply device 7 to the reaction space 26 through the supply pipe 71. In addition, carbon dioxide is supplied from the second supply pipe 77 to the reaction space 26. That is, the rotary reactor 1 in the absorption process is a gas-liquid reaction system reactor that reacts an aqueous potassium carbonate solution (liquid) with carbon dioxide (gas). More specifically, the rotary reactor 1 causes a chemical reaction of absorbing carbon dioxide by dissolving acidic carbon dioxide in an alkaline aqueous potassium carbonate solution.

First, the operation of the rotary reactor 1 in the absorption process will be described. During the operation of the rotary reactor 1, first, the pump 75 of the supply device 7, a motor pump (not shown) for circulating the first medium 11, and the motor 23 connected to the heat transfer cylindrical body 3 are driven.

When the pump 75 of the supply device 7 is driven, the aqueous potassium carbonate solution is supplied into the reaction space 26. Since the outer cylinder 4 is sealed, the aqueous potassium carbonate solution flowing into the reaction space 26 from the lower portion of the outer cylinder 4 accumulates in the reaction space 26 such that the water surface gradually moves upward. In addition, carbon dioxide is supplied from the second supply pipe 77.

In addition, the first medium 11 is circulated inside the heat transfer cylindrical body 3 by driving a motor pump (not shown). As a result, the first medium 11 and the second medium 12 (aqueous potassium carbonate solution) exchange heat with each other through the heat transfer cylindrical body 3, and the temperature of the aqueous potassium carbonate solution rises.

Here, in the reaction space 26, a chemical reaction represented by the following formula (1) occurs by mixing an alkaline aqueous potassium carbonate solution and acidic carbon dioxide.

K₂CO₃+CO₂+H₂O→2KHCO₃ (1)

As a result, carbon dioxide is absorbed, and an aqueous potassium hydrogen carbonate solution (liquid) is generated. Thereafter, the unreacted aqueous potassium carbonate solution is returned to the tank 70 through the recovery pipe 73, and is supplied to the reaction space 26 again through the supply pipe 71. Carbon dioxide is sequentially supplied from the second supply pipe 77. Thus, carbon dioxide can be continuously absorbed by circulating the aqueous potassium carbonate solution. The recovery pipe 73 may include, for example, a separation device that recovers both the aqueous potassium carbonate solution and potassium hydrogen carbonate and then circulates only the aqueous potassium carbonate solution.

In addition, by driving the motor 23 connected to the heat transfer cylindrical body 3, the heat transfer cylindrical body 3 rotates about the central axis C. When the heat transfer cylindrical body 3 rotates relative to the outer cylinder 4 and the blade 6, the flow of the fluid that tries to swirl with the rotation of the heat transfer cylindrical body 3 is restricted by the blade 6, so that the flow of the fluid in the reaction space 26 is disturbed. Thus, the fluid in the reaction space 26 is stirred, and the gas (carbon dioxide) supplied from the supply device 7 is finely dispersed by a shearing force of the blade 6 to form small bubbles. This increases a contact area between the carbon dioxide and the aqueous potassium carbonate solution, that is, a reaction interfacial area between the carbon dioxide and the aqueous potassium carbonate solution. Thus, the chemical reaction of the formula (1) is likely to occur, and carbon dioxide can be more efficiently absorbed.

Next, in order to describe the effect of the rotary reactor 1, experimental results in the above-described absorption process will be described.

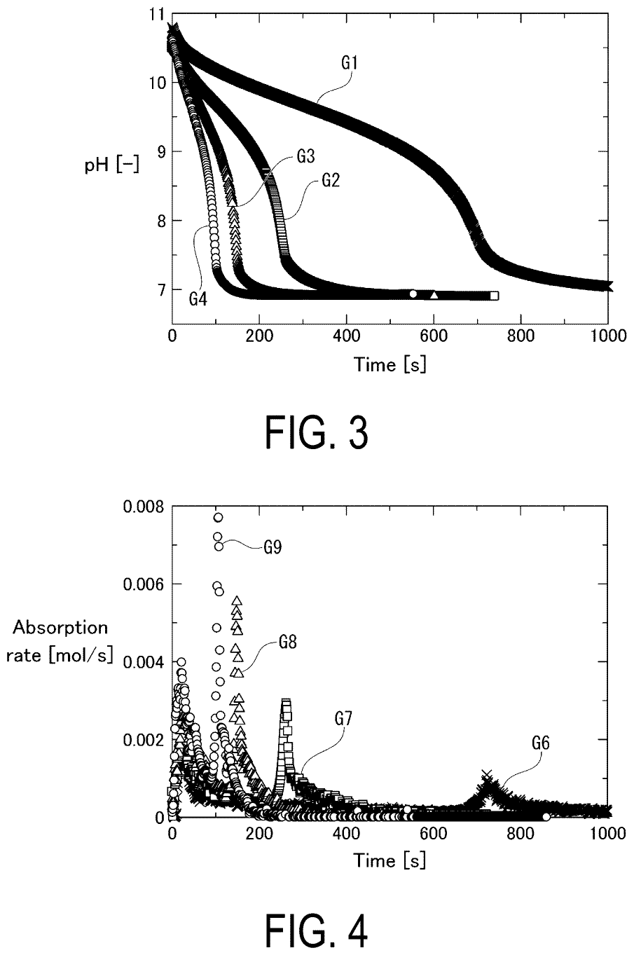

FIG. 3 is a graph showing a temporal change in a hydrogen ion index (pH) in the reaction space 26.

In FIG. 3, a graph G1 shows a temporal change in pH in the reaction space 26 when the number of rotations of the heat transfer cylindrical body 3 is set to 0 (no rotation). Graphs G2 to G4 show temporal changes in pH when the number of rotations of the heat transfer cylindrical body 3 is set to 1000 rpm, 2000 rpm, and 3000 rpm, respectively.

As shown in FIG. 3, the pH gradually decreases from about pH 11 to about pH 7 with the lapse of time regardless of the number of rotations. This is a result that the alkaline aqueous potassium carbonate solution reacts with acidic carbon dioxide and approaches neutrality. Here, comparing the graph G1 with the graphs G2 to G4, a time required for a change from alkaline to neutral is shorter in the case of the presence of rotation of the heat transfer cylindrical body 3 (graphs G2 to G4) than in the case of the absence of rotation of the heat transfer cylindrical body 3 (graph G1). That is, it can be seen that the reaction speed is faster in the case of the presence of rotation than in the case of the absence of rotation. In addition, when the graphs G2 to G4 are compared with each other, it can be seen that the reaction speed is improved as the number of rotations of the heat transfer cylindrical body 3 is larger when the number of rotations is from 1000 to 3000 rpm.

FIG. 4 is a graph showing a temporal change in absorption rate in the reaction space 26. A graph G6 in FIG. 4 shows a temporal change in the absorption rate of carbon dioxide in the reaction space 26 when the number of rotations of the heat transfer cylindrical body 3 is set to 0. Graphs G7 to G9 show temporal changes in the absorption rate of carbon dioxide when the number of rotations of the heat transfer cylindrical body 3 is set to 1000 rpm, 2000 rpm, and 3000 rpm, respectively.

As shown in FIG. 4, regardless of the number of rotations, there are two timings at which the absorption rate of carbon dioxide rapidly increases. This is because the pH in the reaction space 26 changes according to the elapsed time from the start of the experiment, thereby changing the state of carbon dioxide. A first peak occurs at a relatively early timing within 100 seconds from the start of the experiment, and a second peak occurs at a relatively late timing after 100 seconds from the start of the experiment. The timing of the first peak is substantially the same regardless of the number of rotations. However, a magnitude of a peak value at the first peak increases as the number of rotations increases.

The timing of the second peak is faster as the number of rotations is larger. For example, as shown in a graph G9, when the number of rotations is 3000 rpm at which the number of rotations is the largest, the second peak is the earliest and occurs after about 100 seconds from the start of the experiment. As shown in a graph G8, when the number of rotations is 2000 rpm, the second peak occurs after about 150 seconds from the start of the experiment. As shown in a graph G7, when the number of rotations is 1000 rpm, the second peak occurs after about 300 seconds from the start of the experiment. As shown in a graph G6, when the number of rotations is 0, the second peak is the slowest and occurs after about 700 seconds from the start of the experiment. In addition, the magnitude of the peak value at the second peak increases as the number of rotations increases. Thus, it can be seen that the larger the number of rotations, the higher the absorption rate, and the more efficient absorption action can be achieved at an earlier timing.

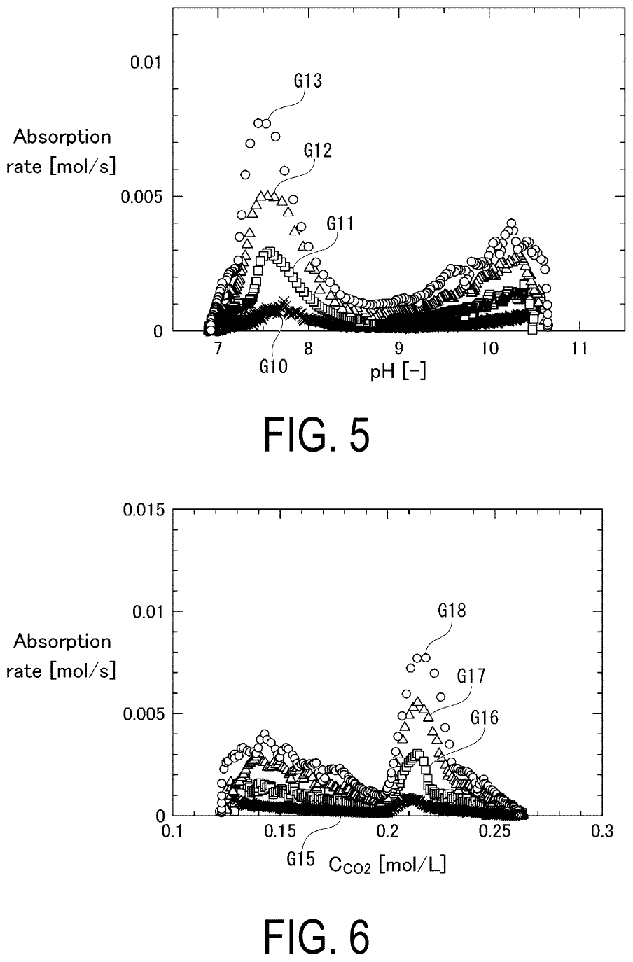

FIG. 5 is a graph showing a relationship between the hydrogen ion index (pH) and the absorption rate. FIG. 5 shows a pH dependence of the absorption rate.

A graph G10 in FIG. 5 shows the pH dependence of the absorption rate when the number of rotations of the heat transfer cylindrical body 3 is set to 0. Graphs G11 to G13 show the pH dependences of the absorption rates when the number of rotations of the heat transfer cylindrical body 3 is set to 1000 rpm, 2000 rpm, and 3000 rpm, respectively.

As shown in FIG. 5, regardless of the number of rotations, the absorption rate of carbon dioxide increases at about pH 7 to 8 and at about pH 10 to 11 as compared with other pH levels. Comparing the graph G10 with the graphs G11 to G13, at any pH level, the absorption rate of carbon dioxide is higher in the case of the presence of rotation of the heat transfer cylindrical body 3 (graphs G11 to G13) than in the case of the absence of rotation of the heat transfer cylindrical body 3 (graph G10). That is, it can be seen that carbon dioxide can be more efficiently absorbed in the case of the presence of rotation than in the case of the absence of rotation. In addition, when the graphs G11 to G13 are compared with each other, it can be seen that the absorption rate is higher as the number of rotations of the heat transfer cylindrical body 3 is larger when the number of rotations is from 1000 to 3000 rpm. In particular, when the graphs G10 and G13 are compared with each other, when the pH is about from 7 to 8, the absorption rate at the number of rotations of 3000 rpm is about 10 times the absorption rate without rotation. Similarly, when the graphs G10 and G13 are compared with each other, when the pH is about from 10 to 11, the absorption rate at the number of rotations of 3000 rpm is about 5 times the absorption rate without rotation.

FIG. 6 is a graph showing a relationship between a carbon dioxide concentration and the absorption rate. FIG. 6 shows a carbon dioxide concentration dependence of the absorption rate.

A graph G15 in FIG. 6 shows the carbon dioxide concentration dependence of the absorption rate when the number of rotations of the heat transfer cylindrical body 3 is set to 0. Graphs G16 to G18 show the carbon dioxide concentration dependence of the absorption rate when the number of rotations of the heat transfer cylindrical body 3 is set to 1000 rpm, 2000 rpm, and 3000 rpm, respectively.

As shown in FIG. 6, comparing the graph G15 with the graphs G16 to G18, the absorption rate of carbon dioxide is higher in the case of the presence of rotation of the heat transfer cylindrical body 3 (graphs G16 to G18) than in the case of the absence of rotation of the heat transfer cylindrical body 3 (graph G15). That is, it can be seen that carbon dioxide can be more efficiently absorbed in the case of the presence of rotation than in the case of the absence of rotation. In addition, when the graphs G16 to G18 are compared with each other, it can be seen that the absorption rate is higher as the number of rotations of the heat transfer cylindrical body 3 is larger when the number of rotations is from 1000 to 3000 rpm.

In addition, as the number of rotations of the heat transfer cylindrical body 3 increases, a rate of change (slope of the graph) in absorption rate when the concentration of carbon dioxide in the liquid changes increases. That is, it can be seen that the larger the number of rotations, the greater the dependence on the carbon dioxide concentration in the liquid. Thus, carbon dioxide can be more efficiently absorbed by suitably adjusting the carbon dioxide concentration in the liquid.

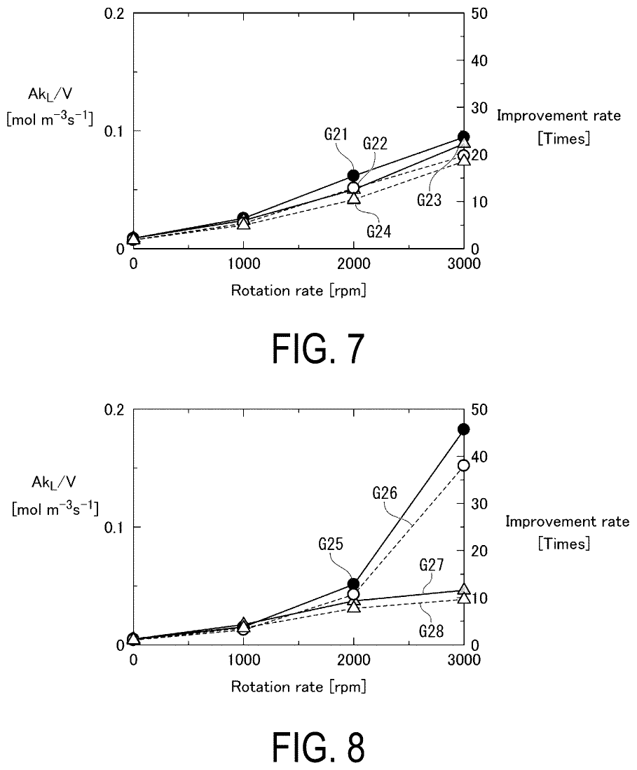

FIG. 7 is a graph showing a relationship between the number of rotations of the heat transfer cylindrical body 3 and a volumetric mass transfer coefficient in the vicinity of pH 8. FIG. 8 is a graph showing the relationship between the number of rotations of the heat transfer cylindrical body 3 and the volumetric mass transfer coefficient in the vicinity of pH 10. FIGS. 7 and 8 show a dependence of the number of rotations of the volumetric mass transfer coefficient. The volumetric mass transfer coefficient is one factor for determining the absorption rate, and the absorption rate is higher as the volumetric mass transfer coefficient is larger.

A graph G21 in FIG. 7 indicates a magnitude of the volumetric mass transfer coefficient with respect to the number of rotations when the gap S is provided between the heat transfer cylindrical body 3 and the blade 6. A graph G22 indicates an improvement rate of the volumetric mass transfer coefficient with respect to the number of rotations when the gap S is provided between the heat transfer cylindrical body 3 and the blade 6. The improvement rate is obtained by dividing the volumetric mass transfer coefficient at each number of rotations by the volumetric mass transfer coefficient when the number of rotations is 0. A graph G23 indicates the magnitude of the volumetric mass transfer coefficient with respect to the number of rotations when the gap S is not provided between the heat transfer cylindrical body 3 and the blade 6. A graph G24 indicates the improvement rate of the volumetric mass transfer coefficient with respect to the number of rotations when the gap S is not provided between the heat transfer cylindrical body 3 and the blade 6.

As shown in the graphs G21 and G23 in FIG. 7, the volumetric mass transfer coefficient increases as the number of rotations increases. The case where the gap S is provided between the heat transfer cylindrical body 3 and the blade 6 (graph G21) has a larger volumetric mass transfer coefficient than the case where the gap S is not provided (graph G23). As shown in the graphs G22 and G24, it can be seen that the improvement rate also increases as the number of rotations increases.

A graph G25 in FIG. 8 indicates the magnitude of the volumetric mass transfer coefficient with respect to the number of rotations when the gap S is provided between the heat transfer cylindrical body 3 and the blade 6. A graph G26 indicates the improvement rate of the volumetric mass transfer coefficient with respect to the number of rotations when the gap S is provided between the heat transfer cylindrical body 3 and the blade 6. A graph G27 indicates the magnitude of the volumetric mass transfer coefficient with respect to the number of rotations when the gap S is not provided between the heat transfer cylindrical body 3 and the blade 6. A graph G28 indicates the improvement rate of the volumetric mass transfer coefficient with respect to the number of rotations when the gap S is not provided between the heat transfer cylindrical body 3 and the blade 6.

As shown in the graphs G25 and G27 in FIG. 8, the volumetric mass transfer coefficient also increases as the number of rotations increases in the vicinity of pH 10. The case where the gap S is provided between the heat transfer cylindrical body 3 and the blade 6 (graph G25) has a larger volumetric mass transfer coefficient than the case where the gap S is not provided (graph G27). As shown in the graphs G26 and G28, it can be seen that the improvement rate also increases as the number of rotations increases.

In addition, when FIG. 7 and FIG. 8 are compared with each other, it can be seen that an influence of the presence or absence of the gap S is large as compared with the case in the vicinity of pH 10 (see FIG. 8) and the case in the vicinity of pH 8 (see FIG. 7). In addition, from the graphs G22 and G24 in FIG. 7 and the graphs G26 and G28 in FIG. 8, it can be seen that when the number of rotations is 3000 rpm, an improvement rate of 10 to 40 times is obtained as compared with the case without rotation. That is, it can be seen that the absorption rate is improved when the number of rotations is increased as compared with the case without rotation.

According to the rotary reactor 1 of the present embodiment, in the reaction space 26 outside the heat transfer cylindrical body 3 and inside the outer cylinder 4, the second medium 12 and the fluid (gas in the present embodiment) supplied by the supply device 7 are mixed to generate a predetermined reaction (for example, chemical reaction, absorption, evaporation. deposition, condensation, and the like). The outer cylinder 4 is provided with the blade 6 extending in the radial direction toward the heat transfer cylindrical body 3, and the heat transfer cylindrical body 3 rotates about the central axis C with respect to the outer cylinder 4 and the blade 6. When the heat transfer cylindrical body 3 rotates, a mixed fluid of the second medium 12 in the reaction space 26 and the gas from the supply device 7 swirls about the central axis C along with the rotation of the heat transfer cylindrical body 3. Since the reaction space 26 is provided with the blade 6, relative rotation of the blade 6 and the heat transfer cylindrical body 3 causes turbulence in the flow of the mixed fluid. As a result, the mixed fluid in the reaction space 26 is stirred, and the gas supplied from the supply device 7 is finely dispersed by the shearing force of the blade 6. By dispersing the gas, a surface area of the gas, that is, the reaction interfacial area with the second medium 12 increases. Thus, the second medium 12 and the gas can be more efficiently reacted, and the reaction speed can be improved. In addition, by a strong stirring action using the blade 6, substance movement in the reaction space 26 can be promoted, and the reaction speed can be further improved.

The first medium 11 flows inside the heat transfer cylindrical body 3, and the second medium 12 having a temperature different from that of the first medium 11 flows outside the heat transfer cylindrical body 3 and inside the outer cylinder 4. As a result, heat exchange is performed between the first medium 11 and the second medium 12 via the heat transfer cylindrical body 3. Thus, the temperature of the fluid in the reaction space 26 can be adjusted, and the reaction can be further promoted. In addition, since the blade 6 extends toward the heat transfer cylindrical body 3, even when deposition occurs on the outer peripheral surface of the heat transfer cylindrical body 3 due to, for example, heat exchange, a substance deposited by the blade 6 can be removed. Thus, the reaction speed can be improved by promoting substance movement while effectively performing heat exchange.

Therefore, it is possible to provide the rotary reactor 1 capable of increasing heat transfer rate and increasing the reaction speed as compared with the known art.

The central member 2 is provided inside the heat transfer cylindrical body 3, and the central member 2 and the heat transfer cylindrical body 3 are configured to be relatively rotatable with respect to each other. In the present embodiment, the heat transfer cylindrical body 3 is rotatably supported via the bearings 17 and 18 provided at both ends. Thus, the heat transfer cylindrical body 3 can be stably rotated. In addition, since the rotation of the heat transfer cylindrical body 3 is stabilized, the heat transfer cylindrical body 3 can be rotated with a larger number of rotations. By rotating the heat transfer cylindrical body 3 at a high speed, the fluid (gas in the present embodiment) supplied by the supply device 7 can be more finely dispersed, and a stirring force can be improved. This makes it possible to further improve the reaction speed.

The supply device 7 allows liquid and gas to flow into the reaction space 26. The rotary reactor 1 disperses the gas flowing into the reaction space 26 by the relative rotation of the heat transfer cylindrical body 3 with respect to the blade 6. By finely dispersing the gas, the reaction speed particularly in the gas-liquid reaction can be improved.

The liquid flowing into the reaction space 26 is an aqueous potassium carbonate solution, and the gas flowing into the reaction space 26 is carbon dioxide. Thus, for example, carbon dioxide can be absorbed in the aqueous potassium carbonate solution by dissolving the carbon dioxide in potassium carbonate. Thus, the rotary reactor 1 can be applied particularly for applications such as the absorption process of carbon dioxide and a separation process of carbon dioxide.

The supply device 7 includes the pump 75, the supply pipe 71 through which a fluid is supplied into the reaction space 26, and the recovery pipe 73 through which the fluid in the reaction space 26 is recovered. The supply device 7 circulates the fluid in the reaction space 26. As a result, the movement of the substance in the reaction space 26 can be further promoted. Thus, the reaction speed can be improved. The supply device 7 is connected to the lower portion of the reaction space 26, and the recovery pipe 73 is connected to an upper portion of the reaction space 26. Thus, the fluid can be circulated along a flow of a swirling flow from the lower side to the upper side generated by the rotation of the heat transfer cylindrical body 3. Thus, the fluid can be efficiently circulated.

The first medium 11 is different in temperature from the second medium 12. As a result, the reaction can be performed at a temperature at which the reaction of the fluid in the reaction space 26 is efficiently performed. Thus, the reaction speed of the fluid in the reaction space 26 can be improved.

### Salt Making Process Using Rotary Reactor

Next, the salt making process using the rotary reactor 1 described above will be described.

In the salt making process, the second medium 12 is seawater. The first medium 11 is, for example, water having a temperature higher than that of the second medium 12. The first medium 11 may be a fluid having a temperature higher than that of the second medium 12, and may be a fluid other than water. The seawater is supplied from the tank 70 of the supply device 7 to the reaction space 26 through the supply pipe 71. In addition, dry air is supplied from the second supply pipe 77 to the reaction space 26. That is, the rotary reactor 1 in the salt-making process is a gas-liquid reaction system reactor that reacts seawater (liquid) with air (gas). More specifically, the salt making process of the present embodiment is a process of evaporating sea water to precipitate sodium chloride, in particular, a process of improving an evaporation rate of the sea water by dissolving moisture in the sea water in dry air.

The operation of the rotary reactor 1 in the salt making process is equivalent to the operation in the absorption process. That is, by driving the pump 75 of the supply device 7, seawater is supplied into the reaction space 26, and dry air is supplied from the second supply pipe 77. The first medium 11 having a high temperature is circulated inside the heat transfer cylindrical body 3 by driving a motor pump (not shown). As a result, the first medium 11 and the second medium 12 (sea water) exchange heat with each other via the heat transfer cylindrical body 3, the temperature of the sea water rises, and the sea water is further evaporated to precipitate sodium chloride.

The unreacted seawater is returned to the tank 70 through the recovery pipe 73, and is supplied to the reaction space 26 again through the supply pipe 71. The dry air is sequentially supplied from the second supply pipe 77. By driving the motor 23, the heat transfer cylindrical body 3 rotates about the central axis C. As a result, the fluid in the reaction space 26 is stirred, and the dry air supplied from the supply device 7 is finely dispersed by the shearing force of the blade 6 to form small bubbles. As a result, the reaction interfacial area between the dry air and the seawater increases. Thus, as compared with a known method of boiling water using fossil fuel or electricity, drying proceeds even at 100° C, or lower, and hot spring heat or warm drainage can be used, so that energy saving can be achieved.

According to the rotary reactor 1 of the present embodiment, the liquid flowing into the reaction space 26 is seawater, and the gas flowing into the reaction space 26 is air. Thus, for example, the rotary reactor 1 can be applied as an application of the salt making process of evaporating sea water to precipitate sodium chloride. In addition, by dispersing the micronized dry air in the seawater, the seawater can be easily evaporated. Thus, it is possible to promote an efficient reaction and to suppress energy related to salt making to a small level.

In addition, since the heat transfer cylindrical body 3 and the blade 6 rotate relative to each other, for example, an attached substance including sodium chloride, other impurities, and the like attached to the outer peripheral surface of the heat transfer cylindrical body 3 can be peeled off by the blade 6. Here, in the salt making process, the blade 6 is in close contact with the heat transfer cylindrical body 3. As a result, it is possible to suppress a decrease in heat transfer efficiency due to adhesion of the attached substance to the outer peripheral surface of the heat transfer cylindrical body 3. Thus, wasteful energy consumption can be suppressed, and the salt making process can be efficiently performed in a shorter time.

Here, in a process in which a solid material is precipitated as in the salt making process, examples of a method of removing (recovering) a precipitated substance (for example, a salt in the above-described salt making process) from the rotary reactor 1 include the following examples.

A first method is a so-called batch process of drying in the rotary reactor 1. In this case, for example, a step of supplying a fluid (seawater in the present embodiment) as a raw material and then taking out a precipitate after a lapse of a predetermined time is performed. After the precipitate is recovered, the raw material is supplied again. By repeating these steps, the precipitate is recovered.

A second method is a method in which a precipitate is concentrated to a slurry state and extracted together with a liquid.

A third method is, in addition to the second method described above, a method of continuously performing the recovery of the precipitate and the supply of the raw material. For example, a region where a stirring force due to rotation does not reach is provided in a lower portion of the rotary reactor 1, a precipitate that has settled is extracted together with a small amount of liquid, and a new raw material is supplied from above the rotary reactor 1. According to this method, since the supply of the raw material and the recovery of the precipitate can be performed simultaneously, a continuous operation can be performed, and work efficiency can be improved.

### Second Embodiment

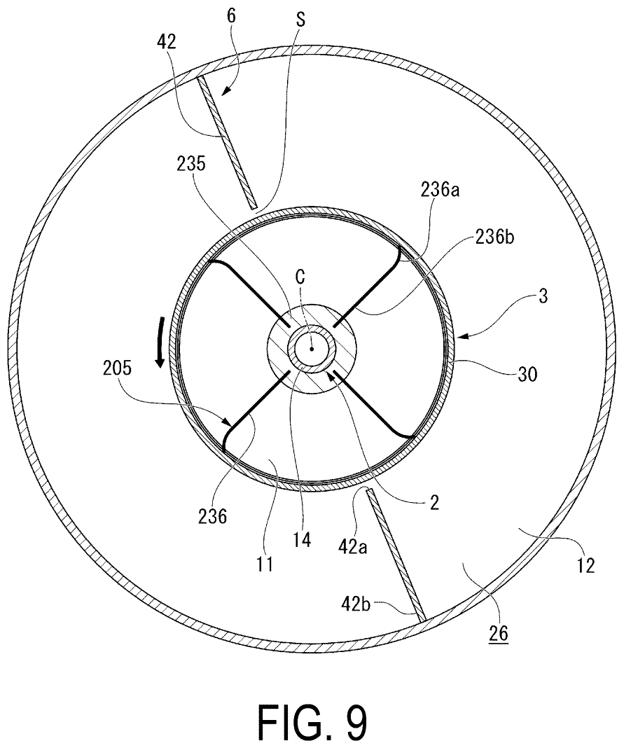

Next, a second embodiment according to the present invention will be described. FIG. 9 is a cross-sectional view of a rotary reactor 1 according to the second embodiment. In the following description, the same reference numerals are given to the same configurations as those of the above-described first embodiment, and the description thereof will be appropriately omitted.

The second embodiment is different from the first embodiment in that a blade (inner blade 205) is also provided inside the heat transfer cylindrical body 3.

In the second embodiment, the rotary reactor 1 further includes the inner blade 205 in addition to the configuration of the first embodiment.

The inner blade 205 is disposed between a central member 2 and the heat transfer cylindrical body 3. The inner blade 205 is attached to the central member 2. The inner blade 205 comes into sliding contact with an inner peripheral surface of the heat transfer cylindrical body 3 when the heat transfer cylindrical body 3 rotates. The inner blade 205 includes an inner blade fixing portion 235 and an inner blade body 236.

The inner blade fixing portion 235 is fixed to an outer peripheral portion of the central member 2. The inner blade fixing portion 235 is formed in a cylindrical shape centered on a central axis C.

The inner blade body 236 is attached to an outer peripheral portion of the inner blade fixing portion 235. A plurality of the inner blade bodies 236 are provided at equal intervals in the circumferential direction. The inner blade body 236 is formed in a rectangular plate shape elongated in the axial direction with the circumferential direction as a plate thickness direction. The inner blade body 236 radially extends outward in the radial direction from the inner blade fixing portion 235 as viewed in the axial direction. A proximal end portion 236b of the inner blade body 236 located on the radially inner side is connected to the outer peripheral portion of the inner blade fixing portion 235. The inner blade body 236 is formed of, for example, an elastic body such as a resin material or rubber.

A distal end portion 236a located on a radially outer side of the inner blade body 236 has higher flexibility than the proximal end portion 236b . Having high flexibility means that a deformation amount is large with respect to stress acting from the outside, and for example, a configuration in which a displacement amount of the distal end portion 236a which is a free end becomes larger as compared with the proximal end portion 236b connected to a fixed end is included. For example, the distal end portion 236a may have high flexibility by being formed such that strength of the material decreases from the proximal end portion 236b toward the distal end portion 236a. The distal end portion 236a may have high flexibility by forming a slit, a hole, or the like in the distal end portion 236a.

The distal end portion 236a of the inner blade body 236 comes into sliding contact with the inner peripheral surface of the heat transfer cylindrical body 3. More specifically, when the heat transfer cylindrical body 3 rotates, the inner blade body 236 comes into sliding contact with the inner peripheral surface of the heat transfer cylindrical body 3 while being curved along an advancing direction side in the rotation direction of the heat transfer cylindrical body 3. Thus, the inner blade body 236 can always come into sliding contact with the heat transfer cylindrical body 3 during rotation of the heat transfer cylindrical body 3.

According to the rotary reactor 1 of the second embodiment, a boundary film of a first medium 11 formed in the vicinity of the inner peripheral surface of the heat transfer cylindrical body 3 can be peeled off by the rotation of the heat transfer cylindrical body 3. As a result, heat transfer resistance in the vicinity of the inner peripheral surface of the heat transfer cylindrical body 3 is reduced, a heat transfer speed between the heat transfer cylindrical body 3 and the first medium 11 increases, and heat exchange can be promoted. Since the distal end portion 236a of the inner blade 205 is softer than the proximal end portion 236b, the distal end portion 236a is flexibly deformed following the rotational operation of the heat transfer cylindrical body 3. As a result, when the heat transfer cylindrical body 3 rotates, the heat transfer cylindrical body 3 and the inner blade 205 can be kept in contact with each other at all times. Thus, by further suppressing remaining of the boundary film, the heat transfer efficiency in the heat exchange can be improved.

The technical scope of the present invention is not limited to the above-described embodiments, and various modifications can be made without departing from the gist of the present invention.

For example, in the above-described embodiment, an example in which the rotary reactor 1 is used as a gas-liquid reaction system reactor for reacting gas with liquid has been described; however, the present invention is not limited this example. Gases, liquids, and solids may be used in any combination. Examples of the reaction of a liquid-liquid reaction system include an example in which an aqueous solution such as water and an oily extraction solvent such as oil are mixed, and an example of mediums that become uniform as they are mixed, such as water, oil, and emulsifier. As another reaction of the gas-liquid reaction, for example, an absorption refrigerator using heat of vaporization when water evaporates can be cited.

The liquid may be supplied from the second supply pipe 77.

The blade 6 may be provided so as to come into sliding contact with the outer peripheral surface of the heat transfer cylindrical body 3 when the heat transfer cylindrical body 3 rotates. The size of the gap S, the number of the blades 6, the shape of the gap S, and the like are not limited to the above-described embodiments. For example, a shape of a long side of the blade 6 facing the heat transfer cylindrical body 3 may be formed in an uneven shape or a wave shape instead of a straight line, so that the fluid can easily pass therethrough. The shape of the blade body 42 is not limited to the above-described rectangular plate shape along the axial direction. The blade body 42 may be formed in a spiral shape along the axial direction, for example. The number of rotations of the heat transfer cylindrical body 3 is not limited to the numerical value of the embodiment.

The outer diameter size and a ratio of the outer diameter in the heat transfer cylindrical body 3 and the outer cylinder 4 are not limited to the shown aspect. For example, when the outer diameter of the heat transfer cylindrical body 3 is reduced with respect to the outer cylinder 4, a volume of the reaction space 26 increases, and a flow rate of the fluid flowing into the reaction space 26 can be increased. On the other hand, when the outer diameter of the heat transfer cylindrical body 3 is increased with respect to the outer cylinder 4, a rotational energy of the heat transfer cylindrical body 3 can be used as the stirring force of the fluid with high efficiency. In this manner, the size of the outer diameter may be changed according to properties of the fluid to be reacted.

In the above-described embodiment, the case where the rotary reactor is vertically placed has been described; however, the present invention is not limited thereto. The rotary reactor may also be disposed horizontally.

The first medium may have a temperature similar to that of the second medium. As described above, the temperature of the second medium may be any temperature suitable for promoting the reaction of the first medium. In addition to the absorption process of the first embodiment described above, for example, in the case of a drying process or a process of obtaining a reaction product weak to heat, it is necessary to cool by lowering the temperature of the second medium.

For example, instead of being attached to the inner periphery of the outer cylinder 4, the blade body 42 may be attached to, for example, the upper and lower end portions of the outer cylinder 4, or may be attached to a component other than the outer cylinder 4.

The blade bodies 42 may not be arranged at equal intervals in the circumferential direction.

In the carbon dioxide absorption process of the first embodiment, an aqueous potassium carbonate solution is used as a solvent for absorbing carbon dioxide; however, the present invention is not limited thereto. For example, instead of the aqueous potassium carbonate solution, for example, an amine absorbent or the like may be used.

In the salt making process of the first embodiment, the gas supplied to the reaction space 26 may be air instead of dry air. However, when dry air is used, there is an advantage in that the absorption rate (reaction speed) is further increased.

The supply device 7 may be omitted. A semi-batch method of concentrating an initially placed fluid may be used.

In addition, it is possible to appropriately replace the constituent elements in the above-described embodiments with well-known constituent elements without departing from the gist of the present invention, and the above-described embodiments may be appropriately combined.

### Reference Signs List

1 Rotary reactor
2 Central member
3 Heat transfer cylindrical body
4 Outer cylinder
6 Blade
7 Supply device
11 First medium
12 Second medium
17 First bearing (bearing)
18 Second bearing (bearing)
26 Reaction space
71 Supply pipe
73 Recovery pipe
75 Pump
C Central axis

1. A rotary reactor comprising:
a heat transfer cylindrical body formed in a cylindrical shape with a central axis as a rotation center and through which a first medium flows through an inside of the heat transfer cylindrical body;
an outer cylinder that is disposed more outward than the heat transfer cylindrical body in a radial direction and through which a second medium different from the first medium flows between the outer cylinder and the heat transfer cylindrical body;
a blade provided more outward than the heat transfer cylindrical body in the radial direction and extending along the radial direction toward the heat transfer cylindrical body; and
a supply device that allows a fluid to flow into a reaction space between the heat transfer cylindrical body and the outer cylinder,
wherein the heat transfer cylindrical body is supported so as to be rotatable about the central axis with respect to the outer cylinder, and
a fluid having a plurality of phases different from each other is supplied to the reaction space.

2. The rotary reactor according to claim 1, wherein
the fluid having the plurality of phases includes at least gas and liquid, and
the gas flowing into the reaction space is dispersed by relative rotation of the heat transfer cylindrical body with respect to the blade to increase a reaction interfacial area.

3. The rotary reactor according to claim 2, wherein
the liquid is an alkaline solution, and
the gas is carbon dioxide.

4. The rotary reactor according to claim 2, wherein
the liquid is seawater, and
the gas is air.

5. The rotary reactor according to claim 1, wherein
the supply device includes:
a pump; and
a supply pipe that is connected to the pump and supplies the fluid to the reaction space.

6. The rotary reactor according to claim 2, wherein
the supply device includes:
a pump; and
a supply pipe that is connected to the pump and supplies the fluid to the reaction space.

7. The rotary reactor according to claim 3, wherein
the supply device includes:
a pump; and
a supply pipe that is connected to the pump and supplies the fluid to the reaction space.

8. The rotary reactor according to claim 4, wherein
the supply device includes:
a pump; and
a supply pipe that is connected to the pump and supplies the fluid to the reaction space.
